(19) United States
(12) Patent Application Publication
(10) Pub. No.: US 2026/0229220 A1
(43) Pub. Date: Aug. 6, 2026

(54) Video Surveillance System and Method for Location-Based Communication

(71) Applicant: Eagle Eye Networks, Inc., Austin, TX (US)

(72) Inventor: Tijmen Vos, Naarden (NL)

(73) Assignee: Eagle Eye Networks, Inc., Austin, TX (US)

(21) Appl. No.: 19/046,803

(22) Filed: Feb. 6, 2025

(51) Int. Cl. G10L 13/08; G06V 20/40

(52) U.S. Cl. CPC G10L 13/08; G06V 20/44

(57) ABSTRACT

Embodiments comprise a data center with one or more servers configured to store text messages in a first language (e.g., a base language), wherein each text message corresponds to an event type. As the data center receives video streams from a plurality of cameras, the server detects an instance of an event type captured by a camera at a location, determines a second language (e.g., a local language) associated with the camera, generates an audio clip containing speech in the second language corresponding to the text message and communicates the audio clip to a speaker to emit the audio.

### BACKGROUND

### Field of the Disclosure

The present invention relates to video surveillance systems, and particularly to cloud-based video surveillance systems configured for detecting a condition or event in a video stream from a camera and communicating to a user associated with the camera's location.

### Description of the Related Art

There are an estimated 7,000 languages spoken in the world. English is spoken the most, but there are many others that are spoken by a substantial number of people. As more people move around globally, the number of people speaking a language in an area may change.

### SUMMARY

Embodiments disclosed herein may provide a system that accommodates different local languages while reducing the resources required to provide granular control of communications related to video cameras.

Embodiments disclosed herein may be directed to a method for a video surveillance system to communicate with an end user about an event in a language associated with the user location. The method may comprise storing, in a data structure stored in a memory, a text message associated with an event type, wherein the text message is stored in a first language; determining a camera is in a location associated with a second language; determining a video stream corresponding to the camera contains an instance of the event type; generating an audio file in the second language based on the stored text message; and communicating the audio file to a speaker associated with the camera, wherein the speaker emits the audio file.

In some embodiments, determining the event comprises an instance of the event type comprises: storing information about the event type and the text message in a bridge associated with the camera and the speaker, wherein the bridge executes instructions for: capturing the video stream corresponding to the camera; determining the event comprises an instance of the event type; generating the audio file in the second language based on the text message; and communicating the audio file to the speaker.

In some embodiments, communicating the audio file to the speaker comprises communicating the audio file to the bridge, wherein the bridge executes instructions for playing the audio file. In some embodiments, communicating the audio file to the speaker comprises: communicating the text and a set of instructions for converting the stored text message to speech in the second language; generating the audio file by the bridge; and communicating the audio file from the bridge to the speaker. In some embodiments, detecting an event captured in a video stream comprises executing a set of instructions on the server to detect motion within a field of view of the camera and determining the motion corresponds to the event type. In some embodiments, the second language comprises a local language.

A system for communicating with a person in the vicinity of a camera, the system comprising: a server communicatively coupled to a plurality of cameras including the camera, the server comprising: a memory storing a database of a plurality of text messages in a first language, each text message corresponding to an event type; and a processor executing a set of instructions for: receiving a video stream from a camera; detecting an event captured in the video stream; determining the event comprises an instance of the event type; determining a second language associated with the camera; and communicating an audio file to a speaker associated with the camera, wherein the speaker emits speech in the second language based on the text message.

In some embodiments, the server executes a set of instructions to perform: generating the audio file in the second language; and communicating the audio file to the speaker. In some embodiments, the system further comprises a bridge associated with the camera and the speaker, wherein communicating the audio file to the speaker comprises communicating the audio file to the bridge, wherein the bridge executes instructions for playing the audio file. In some embodiments, the server executes a set of instructions for communicating the text message and a set of instructions for converting the text message to speech in the language associated with the camera to a bridge; and the bridge executes a set of instructions for: generating an audio file based on the text message; and communicating the audio file from the bridge to the speaker. In some embodiments, the server executes a set of instructions for: detecting motion; and determining the motion corresponds to an event. In some embodiments, the text message is in a first language; and the language associated with the camera is in a second language different from the first language. In some embodiments, the second language comprises a local language.

Embodiments disclosed herein may be directed to a system comprising a server communicatively coupled to a plurality of cameras. The server comprises a memory storing: a database of a plurality of text messages, each text message corresponding to an event type; and a plurality of sets of text-to-speech instructions, each set of text-to-speech instructions being executable to convert a text message of the plurality of text messages into a language of a plurality of languages. The server also comprises a processor executing a set of instructions for: receiving a video stream from a camera of the plurality of cameras; detecting an event captured in the video stream; determining the event comprises an instance of the event type; determining a language associated with the camera from the plurality of languages; and communicating an audio file to a speaker associated with the camera, wherein the speaker emits speech in the language associated with the camera based on the text message stored in the database.

In some embodiments, the server comprises a set of audio instructions to perform: generating an audio file in the language associated with the camera; and communicating the audio file to the speaker. In some embodiments, the system further comprises: a bridge associated with the camera and the speaker, wherein the server comprises a set of instructions for communicating the audio file to the bridge; and the bridge executes instructions for playing the audio file. In some embodiments, the server executes a set of instructions for communicating the text message and a set of instructions for converting the text message to speech in the language associated with the camera to a bridge, and the bridge executes a set of instructions for: generating an audio file based on the text message; and communicating the audio file from the bridge to the speaker. In some embodiments, the server executes a set of instructions for: detecting motion; and determining the motion corresponds to an event. In some embodiments, the text message is in a first language; and the language associated with the camera is in a second language different from the first language. In some embodiments, the second language comprises a local language.

To further clarify the above and other advantages and features of the present invention, a more particular description of the invention will be rendered by reference to specific embodiments thereof that are illustrated in the appended drawings.

### BRIEF DESCRIPTION OF DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a system architecture of one embodiment of a system for communicating text to speech in a language corresponding to a camera site;

FIGS. 2-7 depict embodiments of user systems for capturing information from devices associated with user sites;

FIG. 8 depicts a system diagram of a system configurable for processing and storing information from devices associated with user sites at a plurality of locations and communicating an audio message to any camera in a language associated with that camera;

FIG. 9 depicts a table as a data structure configurable to store text messages associated with events and event types;

FIG. 10 depicts a table as a data structure configurable to store camera information including languages associated with locations;

FIG. 11 depicts a flow diagram, illustrating a method for communicating an audio message to a user near a camera, wherein the audio message is in a language based on the geographic location of the camera; and

FIG. 12 depicts a system diagram of an information handling system configurable for processing and storing information from devices associated with user sites at a plurality of locations, wherein each location may be associated with a language.

### DETAILED DESCRIPTION OF THE INVENTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a reference numeral refers to a class or type of entity, and any letter or hyphenated numeral following such reference numeral refers to a specific instance of a particular entity of that class or type. Thus, for example, a hypothetical entity referenced by ‘12A’ or ‘12-1’ may refer to a particular instance of a particular class/type, and the reference ‘12’ may refer to a collection of instances belonging to that particular class/type or any one instance of that class/type in general.

As used herein the term “motion” may refer to a change in position of a part of an object and may further correspond with stationary position of the object, whereas the term “movement” may refer to a translational change in position of the object. Thus, a person waving an arm or sitting down, a car door opening or a tree branch swaying would be considered motion, whereas the person walking, the vehicle driving or the tree being uprooted would be considered movement. Embodiments disclosed herein may determine whether there is motion and determine whether the object is stationary or the object is moving.

As used herein, the term “location” may be a geographic reference (which may refer to global positioning system (GPS) coordinates or may refer to an address) associated with a language. Thus, a country may be a location, but a city within the country may also be a location if the city has a different language (including an additional language or an alternative language). Thus, a large country such as India may have several associated languages, depending on the location within the different states, regions, and cities.

The term “site” may refer to a business, enterprise, or some other user-based reference. Thus, an enterprise may be associated with multiple sites, and each site may be associated with a different location. As a result, if there are cameras 10 at the different sites, communicating the same audio message to a person in the vicinity of a camera 10 will typically require transmitting the audio message in a language associated with the location.

As used herein, the term “language” may refer to a general language but may also refer to a dialect or variation of a general language. For example, Hindi is an official language of India, but within India, there are over 20 “officially recognized” languages, over 100 identified languages and over 19,000 dialects.

### System Overview

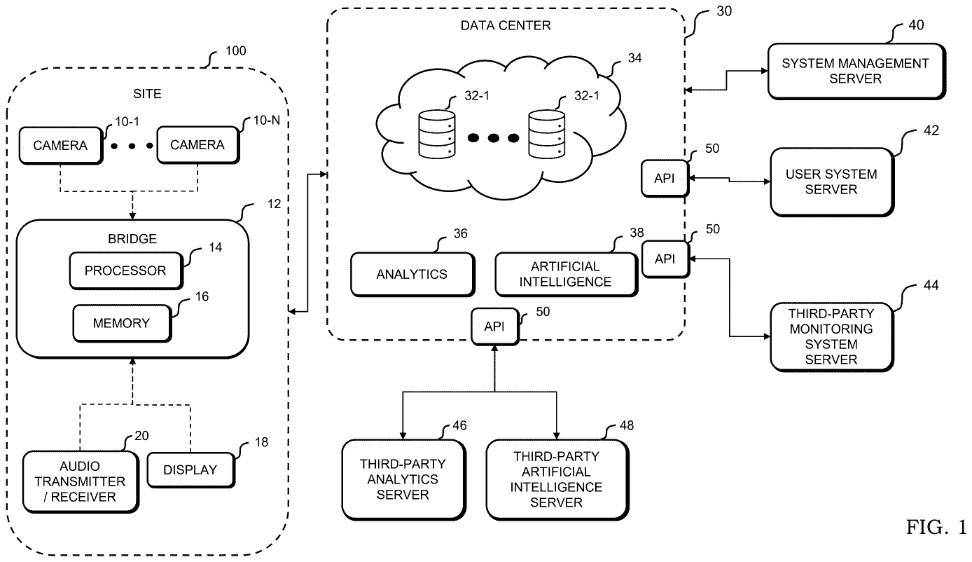

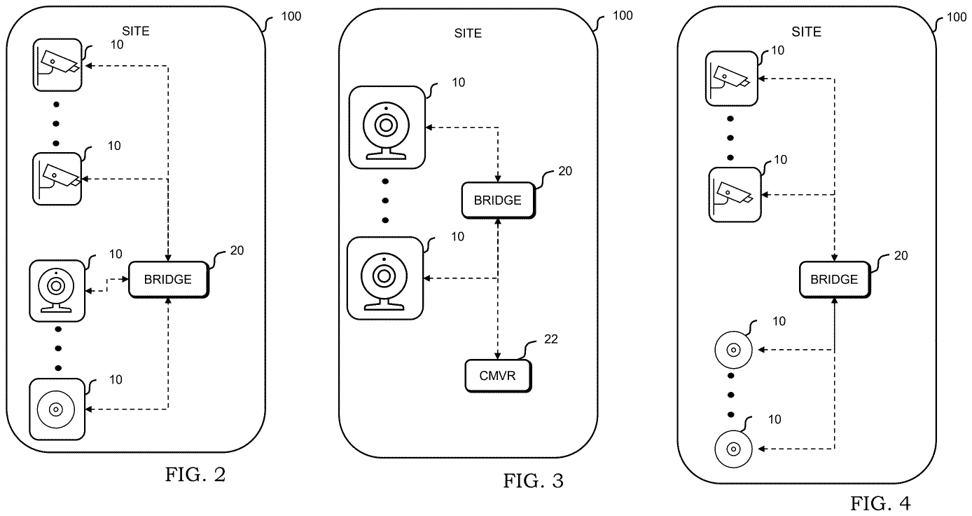

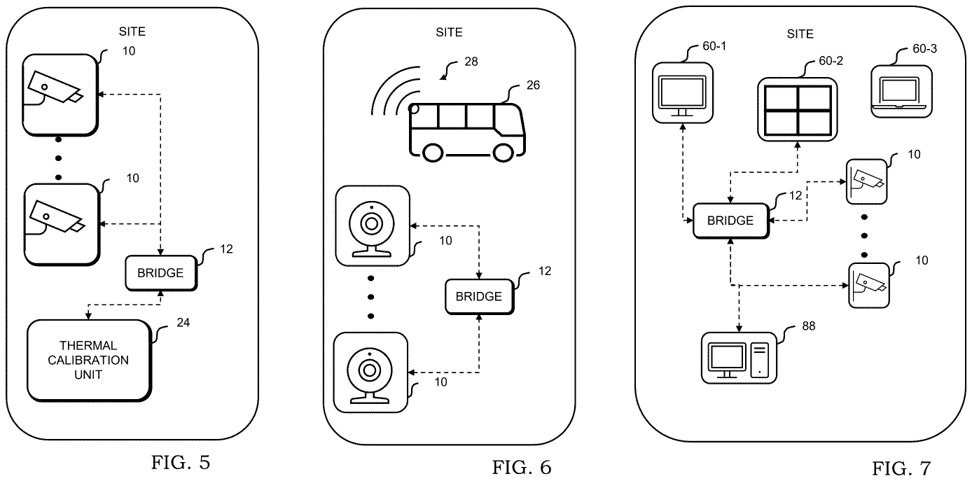

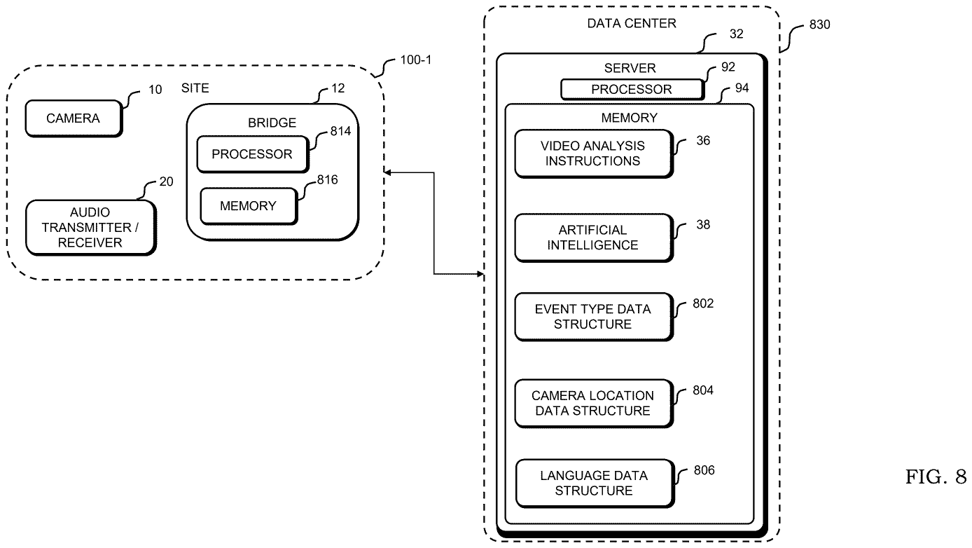

Turning to FIG. 1, a system architecture of embodiments disclosed herein may comprise a plurality of cameras 10 at site 100 communicatively coupled to data center 30. Site 100 may comprise a set of cameras 10 communicatively coupled to bridge 12. Bridge 12 may comprise processor 14 and memory storing a set of instructions and may communicate with display 18 and audio transmitter/receiver 20.

### Cameras

Cameras 10 may comprise analog and/or digital (e.g., Internet Protocol or “IP”) cameras 10 for capturing video streams and other information relating to an environment. Cameras 10 may include, but are not limited to, directional cameras 10, 360-degree cameras 10, fish-eye cameras 10, black-and-white video cameras 10, color cameras 10, high resolution cameras 10, low-resolution cameras 10 and/or infrared cameras 10 for capturing video information. One or more cameras 10 may comprise proprietary cameras 10 associated with Eagle Eye Networks, Inc. of Austin, Texas. In some embodiments, one or more cameras 10 may be manufactured by a third-party enterprise.

At sites 100, cameras 10 may be located inside or outside a structure (e.g., an office building, a school, or a warehouse) or near an area (e.g., near elevators or an entrance to a building, near a playground, in a park or in a parking lot). Referring to FIG. 6, in some embodiments, cameras 10 and/or bridge 20 may be in vehicle 90 with mobile network device 92 configured to communicate with data center 30 over a network (e.g., cellular or Wi-Fi).

Cameras 10 may be selected and positioned to capture video streams and other information. For example, camera 10 may be positioned to capture video streams and other information associated with fire detection, positioned to capture video streams and other information related to any motion, a 360-degree camera 10 selected and positioned near an elevator or in a room to capture video streams and other information relating to movement of people, a directional camera 10 positioned and directed toward a door to capture video streams and other information relating to movement of people through the door or positioned and directed toward a gate to capture video streams and other information relating to movement of vehicles through the gate.

### Bridges

Embodiments of bridge 20 may receive information (including single images and video streams comprising a plurality of images) from cameras 10 and communicate images, video streams and other information to data center 30. Information may include, for example, a video stream and may also include a temperature reading, a sound level, and/or information about a specific camera 10 associated with the information. In some embodiments, bridge 20 may receive information from one or more cameras 10 and directly communicate the information to data center 30. In some embodiments, bridge 20 may receive information from one or more cameras 10 and analyze or process at least a portion of the information before communicating the information to data center 30. In some embodiments, bridge 20 may receive information from one or more cameras 10 and store at least a portion of the information before communicating the information to data center 30. Thus, communicatively coupling cameras 10 to bridges 20 and communicatively coupling bridges 20 to data center 30 may refer to directly or indirectly communicating information from cameras 10 to data center 30, communicating information from cameras 10 through bridges 20 to data center 30, and/or analyzing, processing or storing at least a portion of the information before communicating the information to data center 30. Embodiments of bridge 20 may be configured to communicate information to data center 30 in real-time, based on time (e.g., at scheduled intervals or at a scheduled time) or based on an event (e.g., in response to a predefined trigger).

### Data Center (Cloud)

Data center 30 may refer to a plurality of servers 32 or other information handling systems configured for processing and storing information. Processing information may include, but is not limited to, receiving information, applying a time/date stamp, associating a user location with camera 10 providing the information, associating a user identifier with camera 10 providing the information, associating a geolocation with camera 10 providing the information, associating device information with camera 10 providing the information and associating a language with camera 10. Processing the information may also include applying artificial intelligence (AI) to the information and/or analyzing the information to determine a make, model, signature or description of a vehicle, determine a number and/or profile (e.g., characteristics of clothes they are wearing, a general size of the person, etc.) of one or more people associated with the information and determine one or more of a movement of a person, a motion of a part of a person or a gesture.

Data center 30 may comprise a single building at a single location or may comprise a collection of buildings in multiple locations such that information received from cameras 10 may be received, processed and stored in a set of servers 32 located in a single building or multiple buildings at a single location or across multiple locations. Data center 30 may be communicatively coupled to system management center 40, one or more user systems 50 and one or more monitoring systems 60. Data center 30 may also be communicatively coupled to third party analytics server 70 and/or third-party artificial intelligence (AI) server 80. User systems 50, third-party monitoring systems 60, third-party analytics servers 70 and third-party AI servers 80 may be communicatively coupled to data center 30 through Application Programming Interfaces (APIs) 90.

Embodiments of data center 30 may comprise a plurality of data storage servers 32, wherein a plurality of data storage servers 32 and/or a plurality of data centers 30 may be collectively referred to as cloud 34. Data storage servers 32 may store information received from cameras 10. In some embodiments, data center 30 may be configured to store information received from a single camera 10 of the plurality of cameras 10 in at least three separate data storage servers 32 for redundant storage. Data center 30 may comprise analytics server 36 and artificial intelligence (AI) server 38, discussed in greater detail below.

In some embodiments, communicatively coupling camera 10 to data center 30 may comprise a direct connection, wherein camera 10 communicates information directly to servers 32 in data center 30. In other embodiments, communicatively coupling camera 10 to data center 30 may comprise an indirect connection, wherein camera 10 communicates information to bridge 20 (represented by dashed lines) and bridge 20 communicates the information to one or more servers 32 in data center 30. Notably, one or more cameras 10 at user location 100 may communicate information directly to data center 30 and/or one or more cameras 10 may communicate information indirectly to data center 30.

### Data Center (Cloud) Information Processing

In some embodiments, information processing may comprise analyzing information corresponding to one or more cameras 10. For example, information processing may include determining a manufacturer of camera 10, an accuracy of camera 10, a minimum threshold (e.g., minimum sound level or illumination) associated with camera 10, a maximum threshold (e.g., maximum sound level or illumination) associated with camera 10, a resolution of camera 10, a frame per second (FPS) processing speed of camera 10, a latency of camera 10, a transmission protocol, or some other information associated with the capabilities of camera 10 for recording and transmitting information. Device information may include, for example, information on a location of camera 10, wherein location information may include absolute information (e.g., geo-positioning system or GPS information) and/or relative location information (e.g., “the north stairwell”).

### Cameras May Be Associated with Locations Associated with Different Languages

Embodiments of a smart surveillance system may be spread over a large geographic area, including multiple jurisdictions and cultural regions, wherein data center 30 may be in a first location (e.g., a country such as the United States) with a first corresponding (or “base”) language (e.g., English) and one or more cameras 10 may be located in another location (or locations) (e.g., Japan, Europe, South America) with a second corresponding (or “local”) language (or languages) (e.g., Japanese, French, Spanish), including variations. Location information may include, for example, location information related to a country, state, province, county, city, or other jurisdiction.

In some embodiments, when a user sets up camera 10, the user may have an opportunity to use the first (base) language or select a preferred (local) language for associating a language with camera 10. In other embodiments, location information may include a geographic location or a jurisdiction to be used as a basis for associating a local language with camera 10.

### A Text Message Associated With An Event Type May Be Stored in a Single Language

Embodiments may store text messages associated with event types in a single (base) language. Thus, even though there are thousands of languages (including variations of languages) in the world, embodiments do not need to store audio files or audio files for each event type in each language.

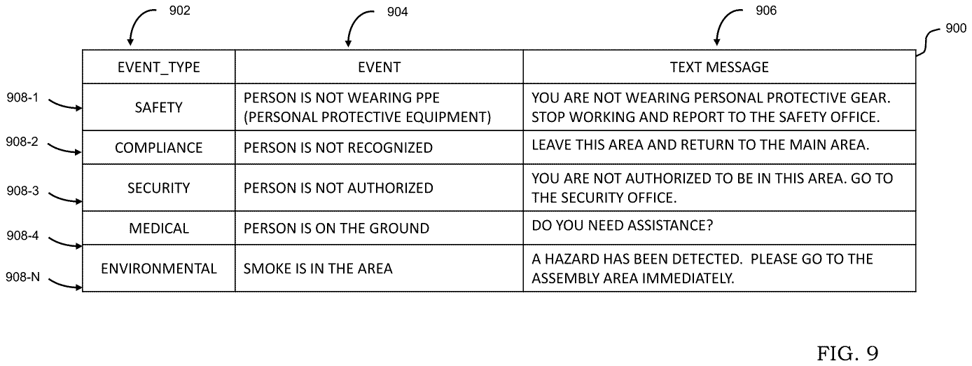

Turning to FIG. 9, embodiments may store data structure 900 (e.g., a table) containing a plurality of rows 902 (e.g., rows 902-1 to 902-N) for different scenarios, wherein for each row 902, columns 904-908 correspond to event type identifiers 904, event type information description 906 and text messages 908. For example, row 902-1 corresponding to a first event identifier (e.g., EVENT_ID_1) 904 defines a first event type associated with event 906 (e.g., “Person not wearing PPE (Personal Protective Equipment)”) and a corresponding text message 908 (e.g., “You are not wearing personal protective gear. Stop working and report to the safety office.”). Thus, if embodiments capture or receive a video stream and determine a person in the vicinity of camera 10 is not wearing PPE, embodiments may communicate an audio message to the user based on text message 906. Notably, each text message 908 may be stored in a first (base) language (e.g., English). Advantageously, a person reviewing text messages 908 only needs to know how to read one (base) language, instead of needing to know how to read or translate into or from hundreds or even thousands of (local) languages.

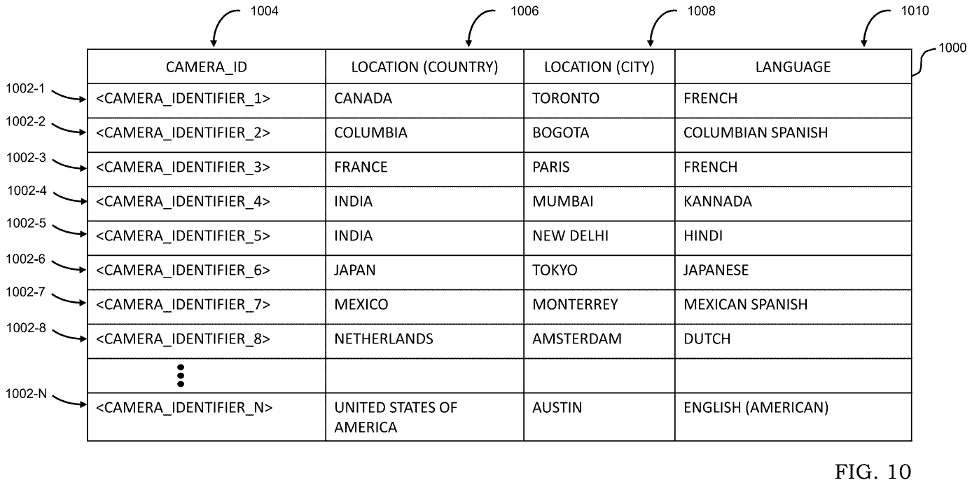

Turning to FIG. 10, embodiments may store information corresponding to each camera 10. In some embodiments, one or more servers 32 may store information for cameras 10. For example, server 32 may store data structure 1000 containing rows 1002, wherein each row 1002 may correspond to a single camera 10 or set of cameras 10 associated with a site associated with a location. For each camera 10, column 1004 may contain a camera identifier, columns 1006 and 1008 may contain location information and column 1010 may contain (local) language information. As an example, row 1002-1 contains information for <camera_identifier_1> 1004, including location information 1006 (e.g., Canada) and location information 1008 (e.g., Toronto) and a corresponding (local) language (e.g., French) 1010.

Combining the examples depicted in FIGS. 9 and 10, if camera 10 corresponding to <camera_identifier_1> captures images of a person not wearing PPE, embodiments may transmit the audio message “You are not wearing Personal Protective Gear. Stop working and report to the Safety Office” into a local language (e.g., French) to a person in the vicinity of <camera_identifier_1>.

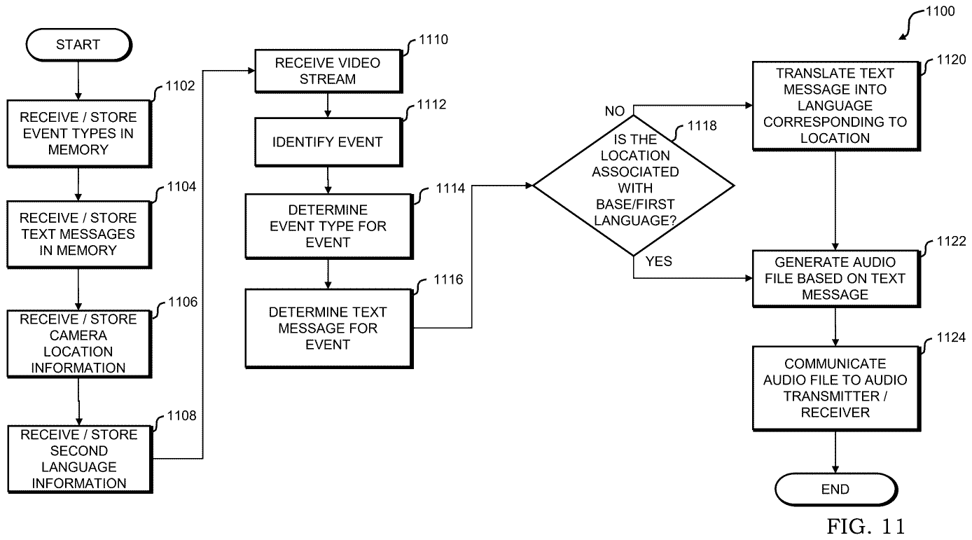

FIG. 11 depicts flow diagram 1100, illustrating steps in a method for transmitting audio messages to cameras 10, wherein multiple audio messages may be based on the same text message associated with the same event type, but each audio message may be based on a local language associated with a specific location.

At step 1102, embodiments may receive and store event types in memory. In some embodiments, receiving an event type may comprise a user specifying an event type. In other embodiments, receiving an event type may comprise server 32 executing a set of instructions to determine an event type. Determining an event type may comprise determining a set of event types that may be associated with a site 100 or location. For example, embodiments may determine a set of event types associated with safety for a construction site 100. In some embodiments, storing an event type may comprise storing information in server 32. In some embodiments, storing an event type may comprise storing information in bridge 12.

At step 1104, embodiments may receive and store text messages in memory. In some embodiments, receiving a text message may comprise a user specifying a text message. In other embodiments, receiving a text message may comprise server 32 executing a set of instructions to determine a text message. In some embodiments, storing a text message may comprise storing information in server 32. In some embodiments, storing a text message may comprise storing information in bridge 12.

At step 1106, embodiments may receive and store camera information in memory. In some embodiments, receiving camera information may comprise a user specifying camera information. In other embodiments, receiving camera information may comprise server 32 executing a set of instructions to communicate with camera 10 to determine camera information. In some embodiments, storing camera information may comprise storing information in server 32. In some embodiments, storing camera information may comprise storing information in bridge 12.

At step 1108, embodiments may receive and store second language information in memory. In some embodiments, receiving second language information may comprise a user specifying local language information. In other embodiments, receiving second language information may comprise server 32 executing a set of instructions to determine second language information, such as a local language or dialect. In some embodiments, storing second language information may comprise storing local language information in server 32. In some embodiments, storing second language information may comprise storing local language information in bridge 12.

In each of steps 1102 to 1108, storing information on bridge 12 may comprise server 32 executing a set of instructions to determine what information to store on bridge 12. For example, server 32 may store a considerable number (e.g., 10,000) of text messages but only a few (e.g., 100) may be relevant to site 100 at which camera 10 is located. Server 32 may execute instructions to determine which text messages are relevant to each camera 10.

In some embodiments, server 32 may execute instructions to determine what information should be communicated to bridge 12. For example, server 32 may execute instructions to determine most people at a site 100 associated with camera 10 are wearing PPE, determine PPE is required at site 100, and identify a set of text message applicable to site 100.

At step 1110, embodiments receive a video stream from camera 10, the video stream comprising a plurality of images.

At step 1112, embodiments may determine an event, wherein an event comprises an object and an action. In some embodiments, determining an event comprises bridge 12 executing a set of instructions to determine a change or difference between two images and determining the change or difference is an event. An object may be a person, vehicle, or animal, but may also include a puff or cloud of smoke, fire, vapor, the presence of water or moisture. An action may comprise translational motion, which may include movement from one area of an image to another area of another image (e.g., a person walking through a field of view of camera 10) or stationary motion (e.g., a fire increasing in intensity but in the same general area). In some embodiments, bridge 20 and or server 32 may execute instructions to analyze a video stream based on one or more text messages stored in memory. For example, if there is a text message related to PPE, embodiments may analyze a video stream to determine whether people are wearing PPE.

### Information Handling Systems

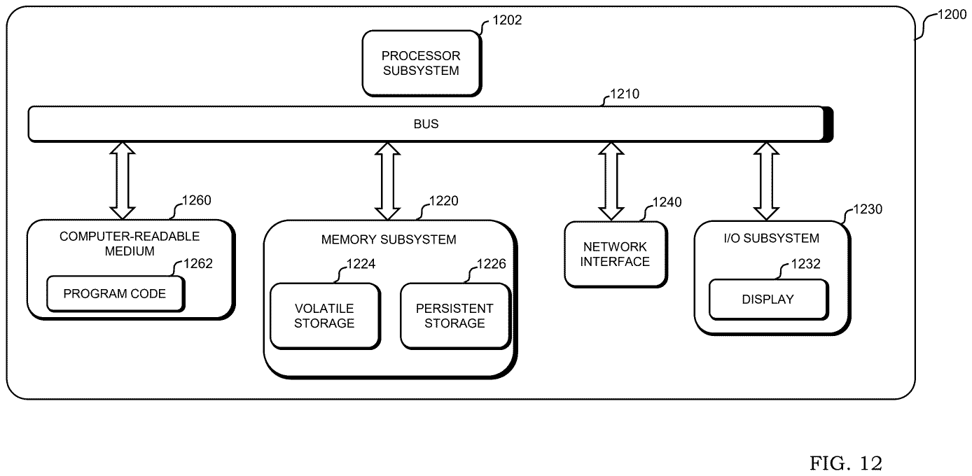

Referring to FIG. 12 and one or more of FIGS. 1, 6 and 7, servers 32 in data center 30, system control center 40, user system 50, third-party systems 60, third-party analytics 70 and third-party artificial intelligence (AI) systems 80 may comprise embodiments of information handling systems 1200. FIG. 12 depicts an information handling system 1200 capable of administering several of the embodiments of the present disclosure. Information handling system 1200 may include processor subsystem 1202 communicatively coupled via system bus 1210 to memory subsystem 1220, input/output (I/O) subsystem 1230 and network interface 1240.

Processor subsystem 1202 may comprise a system, device, or apparatus operable to interpret and execute program instructions and process data, and may include a microprocessor, microcontroller, digital signal processor (DSP), application specific integrated circuit (ASIC), or another digital or analog circuitry configured to interpret and execute program instructions and process data. In some embodiments, processor subsystem 1202 may interpret and execute program instructions and process data stored locally (e.g., in memory subsystem 1220). In the same or alternative embodiments, processor subsystem 1202 may interpret and execute program instructions and process data stored remotely (e.g., in a network storage resource). Processor subsystem 1202 may include components such as a central processing unit (GPU) and a graphics processing unit (GPU).

System bus 1210 may refer to a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

Memory subsystem 1220 may comprise a system, device, or apparatus operable to retain and retrieve program instructions and data for a period (e.g., computer-readable media). Memory subsystem 1220 may comprise one or more volatile storage 1224 and persistent storage 1226. Storage may comprise random access memory (RAM), electrically erasable programmable read-only memory (EEPROM), a PCMCIA card, flash memory, magnetic storage, opto-magnetic storage or a suitable selection or array of volatile or non-volatile memory that retains data after power is removed.

I/O subsystem 1230 may comprise a system, device, or apparatus operable to receive and transmit data to or from or within information handling system 1200. I/O subsystem 1230 may represent, for example, a variety of communication interfaces, graphics interfaces, video interfaces, user input interfaces, and peripheral interfaces. In various embodiments, I/O subsystem 1230 may support various peripheral devices, such as a touch panel, a display adapter, a keyboard, an accelerometer, a touch pad, a gyroscope, or a camera, among other examples. In some implementations, I/O subsystem 1230 may support so-called ‘plug and play’ connectivity to external devices, in which the external devices may be added or removed while information handling system 1200 is operating. In some embodiments, information handling system 1200 may further include display 1232. Display 1232 may be of a variety of display types, such as a liquid crystal display (LCD), an organic light emitting diode (OLED), a flat panel display, a solid-state display, or a cathode ray tube (CRT). Display 1232 may include one or more touch screen display modules and touch screen controllers for receiving user inputs to information handling system 1200. Additionally, information handling system 1200 may include an input device, such as a keyboard, and a cursor control device, such as a mouse or touchpad or similar peripheral input device.

Network interface 1240 may be a suitable system, apparatus, or device operable to serve as an interface between information handling system 1200 and a network (not shown). Network interface 1240 may enable information handling system 1200 to communicate over the network using a suitable transmission protocol or standard. In some embodiments, network interface 1240 may be communicatively coupled via the network to a network storage resource (not shown). The network coupled to network interface 1240 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and messages (generally referred to as data). The network coupled to network interface 1240 may transmit data using a desired storage or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), or any combination thereof. The network coupled to network interface 1240 or various components associated therewith may be implemented using hardware, software, or any combination thereof.

Still referring to FIG. 12, computer program product 1260 may comprise computer-readable media 1270 storing program code 1262. Program code 1262 may be loaded onto or transferred to information handling system 1200 for running by processor subsystem 1202.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures and may be implemented in general purpose and special-purpose computing systems, or other devices having processing capability. Any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method for a video surveillance system to communicate with an end user about an event in a language associated with the user location, the method comprising:
storing, in a data structure stored in a memory, a text message associated with an event type, wherein the text message is stored in a first language;
determining a camera is in a location associated with a second language;
determining a video stream corresponding to the camera contains an instance of the event type;
generating an audio file in the second language based on the stored text message; and
communicating the audio file to a speaker associated with the camera, wherein the speaker emits the audio file.

2. The method of claim 1, wherein determining the event comprises an instance of the event type comprises:
storing information about the event type and the text message in a bridge associated with the camera and the speaker, wherein the bridge executes instructions for:
capturing the video stream corresponding to the camera;
determining the event comprises an instance of the event type;
generating the audio file in the second language based on the text message; and
communicating the audio file to the speaker.

3. The method of claim 1, wherein communicating the audio file to the speaker comprises:
communicating the audio file to the bridge, wherein the bridge executes instructions for playing the audio file.

4. The method of claim 1, wherein communicating the audio file to the speaker comprises:
communicating the text and a set of instructions for converting the stored text message to speech in the second language;
generating the audio file by the bridge; and
communicating the audio file from the bridge to the speaker.

5. The method of claim 1, wherein detecting an event captured in a video stream comprises:
executing a set of instructions on the server to detect motion within a field of view of the camera; and
determining the motion corresponds to the event type.

6. The method of claim 1, wherein the second language comprises a local language.

7. A system for communicating with a person in the vicinity of a camera, the system comprising:
a server communicatively coupled to a plurality of cameras including the camera, the server comprising:
a memory storing a database of a plurality of text messages in a first language, each text message corresponding to an event type; and
a processor executing a set of instructions for:
receiving a video stream from a camera;
detecting an event captured in the video stream;
determining the event comprises an instance of the event type;
determining a second language associated with the camera; and
communicating an audio file to a speaker associated with the camera,
wherein the speaker emits speech in the second language based on the text message.

8. The system of claim 7, wherein the server executes a set of instructions to perform:
generating the audio file in the second language; and
communicating the audio file to the speaker.

9. The system of claim 8, further comprising a bridge associated with the camera and the speaker, wherein communicating the audio file to the speaker comprises:
communicating the audio file to the bridge, wherein the bridge executes instructions for playing the audio file.

10. The system of claim 7, wherein:
the server executes a set of instructions for:
communicating the text message and a set of instructions for converting the text message to speech in the language associated with the camera to a bridge; and the bridge executes a set of instructions for:
generating an audio file based on the text message; and
communicating the audio file from the bridge to the speaker.

11. The system of claim 7, wherein:
the server executes a set of instructions for:
detecting motion; and
determining the motion corresponds to an event.

12. The system of claim 7, wherein:
the text message is in a first language; and
the language associated with the camera is in a second language different from the first language.

13. The system of claim 12, wherein the second language comprises a local language.

14. A system comprising:
a server communicatively coupled to a plurality of cameras, the server comprising:
a memory storing a database of a plurality of text messages, each text message corresponding to an event type;
a plurality of sets of text-to-speech instructions, each set of text-to-speech instructions being executable to convert a text message of the plurality of text messages into a language of a plurality of languages; and
a processor executing a set of instructions for:
receiving a video stream from a camera of the plurality of cameras;
detecting an event captured in the video stream;
determining the event comprises an instance of the event type;
determining a language associated with the camera from the plurality of languages; and
communicating an audio file to a speaker associated with the camera, wherein the speaker emits speech in the language associated with the camera based on the text message stored in the database.

15. The system of claim 14, wherein the server comprises a set of audio instructions to perform:
generating an audio file in the language associated with the camera; and
communicating the audio file to the speaker.

16. The system of claim 15, further comprising:
a bridge associated with the camera and the speaker, wherein
the server comprises a set of instructions for communicating the audio file to the bridge; and
the bridge executes instructions for playing the audio file.

17. The system of claim 14, wherein:
the server executes a set of instructions for:
communicating the text message and a set of instructions for converting the text message to speech in the language associated with the camera to a bridge; and
the bridge executes a set of instructions for:
generating an audio file based on the text message; and
communicating the audio file from the bridge to the speaker.

18. The system of claim 14, wherein:
the server executes a set of instructions for:
detecting motion; and
determining the motion corresponds to an event.

19. The system of claim 14, wherein:
the text message is in a first language; and
the language associated with the camera is in a second language different from the first language.

20. The system of claim 19, wherein the second language comprises a local language.
